(19) United States
(12) Patent Application Publication
(10) Pub. No.: US 2022/0292413 A1
(43) Pub. Date: Sep. 15, 2022

(54) BIKE SHARING REBALANCING OPTIMIZATION METHOD BASED ON ADAPTIVE NEIGHBORHOOD SEARCH ALGORITHM

(71) Applicants: Beijing University of Chemical Technology, Beijing (CN); Beijing Intelligent Transportation Development Center, Beijing (CN)

(72) Inventors: Xiang LI, Beijing (CN); Bowen ZHANG, Beijing (CN); Haitao YU, Beijing (CN); Sicheng ZHANG, Beijing (CN); Randong XIAO, Beijing (CN)

(21) Appl. No.: 17/496,816

(22) Filed: Oct. 8, 2021

(30) Foreign Application Priority Data
Mar. 12, 2021 (CN) 202110289562.2

(51) Int. Cl. G06Q 10/04; G06F 17/11

(52) U.S. Cl. CPC G06Q 10/047; G06F 17/11

(57) ABSTRACT

The present disclosure provides a bike sharing rebalancing optimization method based on an adaptive neighborhood search algorithm. First, based on a difference between locations of shared bikes and users' travel demands in temporal and spatial distribution, a bike sharing rebalancing model is constructed. Next, an adaptive neighborhood search algorithm is constructed by using an adaptive operator selection mechanism and based on the fusion of a large neighborhood search algorithm and a neighborhood search algorithm. Then, seven types of perturbation operators, six types of repair operators, and eight types of neighborhood search operators are designed based on features of rebalancing time, pickup-and-delivery actions, and a capacity limit of a vehicle. Finally, a termination condition is constructed such that the algorithm terminates at an appropriate time and an optimization solution for a rebalancing route is provided.

### CROSS-REFERENCE TO RELATED APPLICATION

This application claims priority to Chinese Application No. 202110289562.2, filed on Mar. 12, 2021, entitled “BIKE SHARING REBALANCING OPTIMIZATION METHOD BASED ON ADAPTIVE NEIGHBORHOOD SEARCH ALGORITHM”, the entirety of which is incorporated herein.

### FIELD

The present disclosure belongs to the field of transportation optimization, and in particular, relates to a bike sharing rebalancing optimization method based on an adaptive neighborhood search algorithm.

### BACKGROUND

In recent years, shared bikes featuring low-carbon, environmental friendliness, health, and sustainability are widely accepted, and have become one of effective ways to resolve the last-mile problem of people's daily travel. Due to imbalance of supply and demand of people's daily travel in temporal and spatial distribution, parking locations of shared bikes often do not match people's travel demand locations. Consequently, a large number of shared bikes are accumulated in some areas, while it is difficult to find a shared bike in other areas.

At present, bike sharing enterprises generally resolve the imbalance of supply and demand through rebalancing operations of shared bikes. In the present disclosure, rebalancing operations of shared bikes mean to use a vehicle (such as an electric tricycle) within a fixed operation scope in a city to transport shared bikes from accumulation locations to locations that lack shared bikes and transport broken shared bikes to a repair station within a specified period of time with a rebalancing cost as low as possible. A rebalancing route of the vehicle is called a bike sharing rebalancing route. In general, optimization of the bike sharing rebalancing route is essentially an optimization process of a pickup and delivery traveling salesman problem (PDTSP). There are many heuristic algorithms that can implement optimization of the PDTSP, including a genetic algorithm (Gao X, Lee G M. Moment-based rental prediction for bicycle-sharing transportation systems using a hybrid genetic algorithm and machine learning[J]. Computers & Industrial Engineering, 2019, 128:60-69.), a memetic algorithm (Lu Y, Benlic U, Wu Q. An effective memetic algorithm for the generalized bike-sharing rebalancing problem[J]. Engineering Applications of Artificial Intelligence, 2020, 95:103890.), a tabu search algorithm (Ho S C, Szeto W Y. Solving a static repositioning problem in bike-sharing systems using iterated tabu search[J]. Transportation Research Part E: Logistics and Transportation Review, 2014, 69:180-198.), and an ant colony algorithm (Bortner C W, Gürkan C, Kell B. Ant colony optimization applied to the bike sharing problem[J]. Retrieved October, 2015, 2:2018.). In the context of rebalancing operations of shared bikes, locations of shared bikes randomly change with users' travel demands. Therefore, scenarios for rebalancing operations of shared bikes are not fixed, and solution spaces of corresponding rebalancing models are quite different. It is difficult to always obtain good calculation effects by using a single heuristic algorithm in different rebalancing scenarios. It can be learned from the current research that a large neighborhood search algorithm (Dell M, Iori M, Novellani S, et al. A destroy and repair algorithm for the bike sharing rebalancing problem[J]. Computers & Operations Research, 2016, 71:149-162.) and a variable neighborhood search algorithm (Pal A, Zhang Y. Free-floating bike sharing: Solving real-life large-scale static rebalancing problems[J]. Transportation Research Part C: Emerging Technologies, 2017, 80:92-116.) have relatively high adaptability in the optimization of the bike sharing rebalancing route. However, different neighborhood search operators have different search capabilities in different rebalancing scenarios. How to design and make full use of advantages of different neighborhood search operators in the optimization of rebalancing operations of shared bikes has become a research gap in academic and industry of this field.

This has not been reported in literature to date.

### SUMMARY

To overcome the disadvantages in the prior art, the present disclosure provides a bike sharing rebalancing optimization method based on an adaptive neighborhood search algorithm to optimize large-scale rebalancing operations of shared bikes, improve efficiency of the rebalancing operations, and reduce rebalancing costs.

The present disclosure provides a bike sharing rebalancing optimization method based on an adaptive neighborhood search algorithm, as shown in FIG. 1, including the following steps:

step 1: constructing, based on locations of shared bikes, users' travel demands, and demand locations to which a vehicle transports the shared bikes, a bike sharing rebalancing model aiming to minimize rebalancing costs; and

step 2: designing an adaptive operator selection mechanism based on rebalancing time, pickup-and-delivery actions, and a capacity limit of the vehicle in the bike sharing rebalancing model, and constructing an adaptive neighborhood search algorithm based on the fusion of a large neighborhood search algorithm and a neighborhood search algorithm, and solving the bike sharing rebalancing model to obtain an optimal rebalancing route of the vehicle.

The large neighborhood search algorithm is composed of a perturbation process and a repair process. The perturbation process is used to delete demand locations on the rebalancing route of the vehicle in the bike sharing rebalancing model, to provide space for improvement of the rebalancing route of the vehicle. The repair process is used to reinsert the demand locations deleted by the perturbation process into the rebalancing route of the vehicle, to reduce the rebalancing costs in the bike sharing rebalancing model. The neighborhood search algorithm is composed of a neighborhood search process. The neighborhood search process is used to swap the demand locations repaired by the repair process on the rebalancing route of the vehicle, to reduce the rebalancing costs in the bike sharing rebalancing model.

In step 1, the bike sharing rebalancing model is composed of two parts: an objective function and constraint conditions.

The objective function is as follows:

$$Min {\sum }_{i ∈ {N}_{0}} {\sum }_{j ∈ {N}_{1} ⋃ {N}_{2} ⋃ {N}_{3}} C {x}_{i j} + {\sum }_{i ∈ {N}_{0}} {\sum }_{j ∈ {N}_{1} ⋃ {N}_{2} ⋃ {N}_{3}} α {t}_{i j} {x}_{i j} \qquad ( 1 )$$

The constraint conditions are as follows:

$${τ}_{j} \geq {t}_{i j} {x}_{i j} - M ( 1 - {x}_{i j} ) , ∀ i ∈ {N}_{0} , j ∈ {N}_{1} ⋃ {N}_{2} ⋃ {N}_{3} \qquad ( 2 )$$

$${τ}_{j} \geq {τ}_{i} + {t}_{i j} {x}_{i j} + \overline{τ} - M ( 1 - {x}_{i j} ) , ∀ i ∈ {N}_{1} ⋃ {N}_{2} ⋃ {N}_{3} , j ∈ N \qquad ( 3 )$$

$$0 \leq {τ}_{i} \leq {T}_{max} , ∀ i ∈ N \qquad ( 4 )$$

$${\sum }_{i ∈ N} {x}_{ii} = 0 \qquad ( 5 )$$

$${\sum }_{j ∈ N} {x}_{ji} = {\sum }_{j ∈ N} {x}_{ij} = 1 , ∀ i ∈ {N}_{1} ⋃ {N}_{2} ⋃ {N}_{3} \qquad ( 6 )$$

$${\sum }_{j ∈ {N}_{1} ⋃ {N}_{2} ⋃ {N}_{3}} {a}_{ij} = {\sum }_{j ∈ {N}_{1} ⋃ {N}_{2} ⋃ {N}_{3}} {b}_{j i} = \vert {N}_{3} \vert , ∀ i ∈ {N}_{0} \qquad ( 7 )$$

$${\sum }_{j ∈ {N}_{1} ⋃ {N}_{2} ⋃ {N}_{3}} {a}_{j i} = {\sum }_{j ∈ {N}_{1} ⋃ {N}_{2} ⋃ {N}_{3}} {b}_{i j} = 0 , ∀ i ∈ {N}_{0} \qquad ( 8 )$$

$${\sum }_{j ∈ N} {a}_{ij} - {\sum }_{j ∈ N} {a}_{ji} = - 1 , ∀ i ∈ {N}_{1} \qquad ( 9 )$$

$${\sum }_{j ∈ N} {a}_{ij} - {\sum }_{j ∈ N} {a}_{ji} = 1 , ∀ i ∈ {N}_{2} \qquad ( 10 )$$

$${\sum }_{j ∈ N} {a}_{ij} - {\sum }_{j ∈ N} {a}_{ji} = 0 , ∀ i ∈ {N}_{3} \qquad ( 11 )$$

$${\sum }_{j ∈ N} {b}_{ij} - {\sum }_{j ∈ N} {b}_{ji} = 0 , ∀ i ∈ {N}_{1} ⋃ {N}_{2} \qquad ( 12 )$$

$${\sum }_{j ∈ N} {b}_{ij} - {\sum }_{j ∈ N} {b}_{ji} = 1 , ∀ i ∈ {N}_{3} \qquad ( 13 )$$

$${a}_{i j} + {b}_{i j} \leq Q {x}_{i j} , ∀ i , j ∈ N \qquad ( 14 )$$

$${x}_{i j} ∈ \{ 0 , 1 \} , {a}_{i j} , {b}_{i j} \geq 0 , {a}_{i j} , {b}_{i j} ∈ Z , ∀ i , j ∈ N \qquad ( 15 )$$

Meanings of parameters in the foregoing model are as follows:

N₀ represents a set of start locations of the vehicles.

N₁ represents a set of locations in which each shared bike needs to be delivered.

N₂ represents a set of locations in which each unbroken shared bike needs to be picked up.

N₃ represents a set of locations in which each broken shared bike needs to be picked up.

N represents a set of all the foregoing locations, and N=N₀∪N₁∪N₂∪N₃.

Q represents a capacity of the vehicle.

C represents a unit labor cost of the vehicle.

τ̅ represents a time taken by the operator (labor) to load or unload a shared bike.

α represents a unit transportation cost of the vehicle.

tᵢⱼ represents a time required for the vehicle to travel from a location i to a location j, where i∈N and j∈N.

Tₘₐₓ represents a maximum operational time allowed for rebalancing operations of shared bikes.

xᵢⱼ represents whether the vehicle travels from the location i to the location j, and if yes, xᵢⱼ is 1, otherwise, xᵢⱼ is 0, where i∈N and j∈N.

xⱼᵢ represents whether the vehicle travels from the location j, to the location i, and if yes, xⱼᵢ is 1, otherwise, xⱼᵢ is 0, where i∈N and j∈N.

xᵢᵢ represents whether the vehicle travels from the location i to the location i, and if yes, xᵢᵢ is 1, otherwise, xᵢᵢ is 0, where i∈N and j∈N.

τᵢ represents a time point at which the vehicle arrives at the location i, where i∈N.

τⱼ represents a time point at which the vehicle arrives at the location j, where j∈N.

aᵢⱼ represents the number of unbroken shared bikes carried by the vehicle on a route from the location i to the location j, where i∈N and j∈N.

aⱼᵢ represents the number of unbroken shared bikes carried by the vehicle on a route from the location j to the location i, where i∈N and j∈N.

bᵢⱼ represents the number of broken shared bikes carried by the vehicle on the route from the location i to the location j, where i∈N and j∈N.

bⱼᵢ represents the number of broken shared bikes carried by the vehicle on the route from the location j to the location i, where i∈N and j∈N.

M represents a very large value in the mathematical model. For example, M may be 1,000,000 in an implementation process.

Z represents that an obtained value is an integer.

In the foregoing model, the construction of the objective function considers labor costs and transportation costs of the vehicle during rebalancing operations of shared bikes. The construction of the constraint conditions considers the features of the rebalancing time, pickup-and-delivery actions, and a capacity limit of the vehicle. The expression (1) is to minimize the labor costs and the transportation costs of vehicles. The expressions (2) and (3) are elimination methods of sub-loops on the rebalancing route. Sub-loops and self-loops are two concepts in the optimization of the rebalancing route of the vehicle. The sub-loops mean that the vehicle continuously travels in a small circle on the rebalancing route of a large circle. The self-loops mean that the vehicle continuously travels around a location in circles. The expression (4) is a rebalancing time constraint, considering the features of the rebalancing time of the vehicle. The expression (5) is an elimination method of self-loops on the rebalancing route. The expression (6) is a flow balance constraint during the rebalancing operations. The expressions (7) and (8) are constraints of numbers of shared bikes carried by the vehicle in the start and end location. The expressions (9), (10), and (11) represent a change in the number of unbroken shared bicycles in the vehicle after the vehicle passes through locations of types N₁, N₂, and N₃, considering the pickup-and-delivery actions in different locations. The expressions (12) and (13) represent a change in the number of broken shared bikes in the vehicle after the vehicle passes through the locations of the types N₁ and N₂, considering the pickup-and-delivery actions of the vehicle in different locations. The expression (14) is a capacity constraint of the vehicle, considering the features of the capacity limit of the vehicle. The expression (15) is a non-negative integer constraint of the decision variable.

In step 2, different weights are assigned to search capabilities of perturbation operators, repair operators, and neighborhood search operators, and the adaptive operator selection mechanism is constructed by using a roulette wheel selection method.

In step 2, there are seven types of perturbation operators: a random perturbation operator, a distance preorder perturbation operator, a distance postorder perturbation operator, a mean distance preorder perturbation operator, a mean distance postorder perturbation operator, a random distance preorder perturbation operator, and a random distance postorder perturbation operator. The adaptive neighborhood search algorithm selects an operator with a strongest capability from the seven operators when it comes to the perturbation process, such that as calculation proceeds, the seven operators play their respective search advantages in the solution space of the bike sharing rebalancing model.

There are six types of repair operators: a random repair operator, an optimal repair operator, a preorder repair operator, a postorder repair operator, a maximum regret repair operator, and a minimum regret repair operator. The adaptive neighborhood search algorithm selects an operator with a strongest capability from the six operators when it comes to the repair process, such that the six operators play their respective advantages in the solution space of the bike sharing rebalancing model.

There are eight types of neighborhood search operators: a single-route point crossover operator, a single-route point-pair crossover operator, a single-route delete-reinsert operator, a single-route segment crossover operator, a dual-route point crossover operator, a dual-route point-pair crossover operator, a dual-route delete-reinsert operator, and a dual-route segment crossover operator. The adaptive neighborhood search algorithm selects an operator with a strongest capability from the eight operators when it comes to the neighborhood search process, such that the eight operators play their respective search advantages in the solution space of the bike sharing rebalancing model.

The seven perturbation operators are constructed as follows:

(1) constructing the random perturbation operator by randomly deleting 40% of rebalancing demand locations and putting the deleted rebalancing demand locations into a demand pool;

(2) constructing the distance preorder perturbation operator by calculating a distance between each rebalancing demand location and its neighboring location, sorting all the rebalancing demand locations in descending order of the distance, deleting first 40% of the rebalancing demand locations, and putting the deleted rebalancing demand locations into the demand pool;

(3) constructing the distance postorder perturbation operator by calculating the distance between each rebalancing demand location and its neighboring location, sorting all the rebalancing demand locations in descending order of the distance, deleting last 40% of the rebalancing demand locations, and putting the deleted rebalancing demand locations into the demand pool;

(4) constructing the mean distance preorder perturbation operator by calculating the distance between each rebalancing demand location and its neighboring location and a mean of the distances, sorting all the rebalancing demand locations in descending order of a difference between the distance and the mean, deleting first 40% of the rebalancing demand locations, and putting the deleted rebalancing demand locations into the demand pool;

(5) constructing the mean distance postorder perturbation operator by calculating the distance between each rebalancing demand location and its neighboring location and the mean of the distances, sorting all the rebalancing demand locations in descending order of the difference between the distance and the mean, deleting last 40% of the rebalancing demand locations, and putting the deleted rebalancing demand locations into the demand pool;

(6) constructing the random distance preorder perturbation operator by calculating the distance between each rebalancing demand location and its neighboring location, sorting all the rebalancing demand locations in descending order of a difference between the distance and a distance corresponding to a randomly selected demand location, deleting first 40% of the rebalancing demand locations, and putting the deleted rebalancing demand locations into the demand pool; and

(7) constructing the random distance postorder perturbation operator by calculating the distance between each rebalancing demand location and its neighboring location, sorting all the rebalancing demand locations in descending order of the difference between the distance and the distance corresponding to the randomly selected demand location, deleting last 40% of the rebalancing demand locations, and putting the deleted rebalancing demand locations into the demand pool.

The six repair operators are constructed as follows:

(1) constructing the random repair operator by randomly selecting a rebalancing demand location in the demand pool each time and putting the selected rebalancing demand location into the rebalancing route;

(2) constructing the optimal repair operator by selecting a rebalancing demand location in the demand pool each time and putting the selected rebalancing demand location into a feasible location with a minimum incremental rebalancing cost on the rebalancing route;

(3) constructing the preorder repair operator by selecting a rebalancing demand location in the demand pool each time and putting the selected rebalancing demand location into a first feasible location on the rebalancing route;

(4) constructing the postorder repair operator by selecting a rebalancing demand location in the demand pool each time and putting the selected rebalancing demand location into a last feasible location on the rebalancing route;

(5) constructing the maximum regret repair operator by calculating the difference between incremental rebalancing costs after each rebalancing demand location in the demand pool is put into an optimal location and a suboptimal location on the rebalancing route, and putting a rebalancing demand location corresponding to a largest difference into the rebalancing route; and

(6) constructing the minimum regret repair operator by calculating the difference between the incremental rebalancing costs after each rebalancing demand location in the demand pool is put into the optimal location and the suboptimal location on the rebalancing route, and putting a rebalancing demand location corresponding to a smallest difference into the rebalancing route.

The eight neighborhood search operators are constructed as follows:

(1) constructing the single-route point crossover operator by randomly swapping two rebalancing demand locations on a single rebalancing route;

(2) constructing the single-route point-pair crossover operator by randomly swapping two pairs of delivery and pickup rebalancing demand locations on a single rebalancing route;

(4) constructing the single-route delete-reinsert operator by randomly deleting a rebalancing demand location from a single rebalancing route and reinserting the rebalancing demand location into another feasible location on the route;

(5) constructing the single-route segment crossover operator by randomly swapping three adjacent rebalancing demand locations on a single rebalancing route;

(6) constructing the dual-route point crossover operator by randomly swapping two rebalancing demand locations of a same type respectively on two rebalancing routes;

(7) constructing the dual-route point-pair crossover operator by randomly swapping two pairs of delivery and pickup rebalancing demand locations of a same type respectively on two rebalancing routes;

(8) constructing the dual-route delete-reinsert operator by randomly deleting a rebalancing demand location from a rebalancing route and reinserting the rebalancing demand location into a feasible location on another rebalancing route; and

(9) constructing the dual-route segment crossover operator by randomly swapping three adjacent rebalancing demand locations on a rebalancing route with those on another rebalancing route.

In step 2, termination conditions of the adaptive neighborhood search algorithm are constructed based on calculation duration and a calculation effect of the adaptive neighborhood search algorithm during execution. If one of the termination conditions is met during the execution of the adaptive neighborhood search algorithm, a current rebalancing route of the vehicle is returned. Otherwise, the rebalancing route of the vehicle is substituted into the adaptive neighborhood search algorithm again for calculation until one of the termination conditions is met, and the rebalancing route of the vehicle is obtained after termination.

The termination conditions of the adaptive neighborhood search algorithm are designed as follows:

(1) comparing a calculation duration threshold with the current calculation duration of the adaptive neighborhood search algorithm, where if the current calculation duration exceeds the threshold, the adaptive neighborhood search algorithm terminates the calculation; otherwise, continues the calculation; and

(2) comparing the rebalancing cost of the rebalancing route obtained in each iteration of the adaptive neighborhood search algorithm, where if the rebalancing cost does not change for a plurality of consecutive times, the adaptive neighborhood search algorithm terminates the calculation; otherwise, continues the calculation.

Compared with the prior art, the present disclosure has the following advantages:

(1) In the present disclosure, various neighborhood search operators are designed based on the rebalancing time, pickup-and-delivery actions, and a capacity limit of the vehicle in rebalancing operations of shared bikes. In addition, the adaptive operator selection mechanism is used and the large neighborhood search algorithm and neighborhood search algorithm are fused to make full use of search capabilities of the neighborhood search operators in different solution spaces. The most suitable search operator is selected in different solution spaces based on the search capabilities of the operators. Therefore, calculation effects of stability and high efficiency can be obtained. Large-scale rebalancing operations of shared bikes can be optimized, efficiency of rebalancing operations of shared bikes is greatly improved, and rebalancing costs are reduced.

(2) In the present disclosure, the large neighborhood search algorithm and neighborhood search algorithm are fused to make full use of the advantages of fast calculation of the large neighborhood search algorithm at an early stage and high search accuracy of the neighborhood search algorithm at a late stage, to improve the efficiency of the rebalancing operations of shared bikes.

(3) Different from current neighborhood search methods, the present disclosure proposes various search operators in the three search processes of perturbation, repair, and neighborhood search to make full use of the search advantages of different search operators in different solution spaces. By fully considering the features of optimizing the bike sharing rebalancing route, the seven perturbation operators, six repair operators, and eight neighborhood search operators are designed to improve the efficiency of the rebalancing operations of shared bikes on the basis of the adaptive operator selection mechanism.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an implementation flowchart of a method according to the present disclosure; and

FIG. 2 is a schematic diagram of a calculation example and an algorithm execution process of bike sharing rebalancing optimization.

### DETAILED DESCRIPTION

To make the objectives, technical solutions, and advantages of the present disclosure clearer, the present disclosure is further described in detail below with reference to the accompanying drawings and embodiments. It should be understood that the specific embodiments described herein are merely intended to explain the present disclosure, rather than to limit the present disclosure. Further, the technical features involved in the various embodiments of the present disclosure described below may be combined with each other as long as they do not constitute a conflict with each other.

The main features of the present disclosure are as follows: First, a bike sharing rebalancing model is constructed based on a difference in supply and demand distribution of shared bikes. Second, an adaptive neighborhood search algorithm is designed to solve the foregoing model. Third, the adaptive neighborhood search algorithm is designed based on the fusion of an adaptive operator selection mechanism, a large neighborhood search algorithm, and a neighborhood search algorithm. Fourth, a previous large neighborhood search algorithm has only one perturbation operator and one repair operator. Although the perturbation operator and the repair operator are different in different scenarios, when these operators have relatively few types, a search capability of the algorithm is relatively limited. A previous neighborhood search algorithm has only one neighborhood search operator. Although the neighborhood search operator is different in different scenarios, when the operator has relatively few types, a search capability of the algorithm is relatively limited. In the present disclosure, various operators are designed in processes of perturbation, repair, and neighborhood search (which is also an innovation), such that the adaptive neighborhood search algorithm can make full use of search capabilities of the operators on the basis of the adaptive operator selection mechanism when solving the bike sharing rebalancing model, to achieve calculation effects of stability and high efficiency. Therefore, the present disclosure proposes a mathematical model of a rebalancing route of a vehicle and provides an adaptive neighborhood search algorithm that can solve the model in the field of bike sharing rebalancing optimization.

The following describes related concepts, symbols, optimization models, and algorithm steps in sequence.

### (A) Basic Concepts

Vehicle: a vehicle that can carry a specific number of shared bikes and travel within a fixed operation scope, which is generally an electric tricycle.

Pickup demand location: a location in which shared bikes that may be unbroken or broken need to be loaded into the vehicle during the rebalancing operations.

Delivery demand location: a location that lacks shared bikes and in which unbroken bikes in the vehicle need to be placed during the rebalancing operations.

Start and end location: a start point and also an end point of the rebalancing route of the vehicle. Finally, the vehicle places broken shared bikes carried in the vehicle in this location for repair.

Rebalancing costs: costs incurred by the vehicle during the rebalancing operations of shared bikes, including labor costs and transportation costs of the vehicle on the route.

### (B) Symbol System

N₀ represents a set of start locations of the vehicles.

N₁ represents a set of locations in which each shared bike needs to be delivered.

N₂ represents a set of locations in which each unbroken shared bike needs to be picked up.

N₃ represents a set of locations in which each broken shared bike needs to be picked up.

N represents a set of all the foregoing locations, and N=N₀∪N₁∪N₂∪N₃.

Q represents a capacity of the vehicle.

C represents a unit labor cost of the vehicle.

τ̅ represents a time taken by the operator (labor) to load or unload a shared bike.

α represents a unit transportation cost of the vehicle.

tᵢⱼ represents a time required for the vehicle to travel from a location i to a location j, where i∈N and j∈N.

Tₘₐₓ represents a maximum operational time allowed for rebalancing operations of shared bikes.

xᵢⱼ represents whether the vehicle travels from the location i to the location j, and if yes, xᵢⱼ is 1, otherwise, xᵢⱼ is 0, where i∈N and j∈N.

xⱼᵢ represents whether the vehicle travels from the location j to the location i, and if yes, xⱼᵢ is 1, otherwise, xⱼᵢ is 0, where i∈N and j∈N.

xᵢᵢ represents whether the vehicle travels from the location i to the location i, and if yes, xᵢᵢ is 1, otherwise, xᵢᵢ is 0, where i∈N and j∈N.

τᵢ represents a time point at which the vehicle arrives at the location i, where i∈N.

τⱼ represents a time point at which the vehicle arrives at the location j, where j∈N.

aᵢⱼ represents the number of unbroken shared bikes carried by the vehicle on a route from the location i to the location j, where i∈N and j∈N.

aⱼᵢ represents the number of unbroken shared bikes carried by the vehicle on a route from the location j to the location i, where i∈N and j∈N.

bᵢⱼ represents the number of broken shared bikes carried by the vehicle on the route from the location i to the location j, where i∈N and j∈N.

bⱼᵢ represents the number of broken shared bikes carried by the vehicle on the route from the location i to the location j, where i∈N and j∈N.

M represents a very large value in the mathematical model. For example, M may be 1,000,000 in an implementation process.

Z represents that an obtained value is an integer.

### (C) Bike Sharing Rebalancing Model

Objective function:

$$Min {\sum }_{i ∈ {N}_{0}} {\sum }_{j ∈ {N}_{1} ⋃ {N}_{2} ⋃ {N}_{3}} {Cx}_{i j} + {\sum }_{i ∈ {N}_{0}} {\sum }_{j ∈ {N}_{1} ⋃ {N}_{2} ⋃ {N}_{3}} α {t}_{i j} {x}_{i j} \qquad ( 1 )$$

Constraint conditions:

$${τ}_{j} \geq {t}_{i j} {x}_{i j} - M ( 1 - {x}_{i j} ) , ∀ i ∈ {N}_{0} , j ∈ {N}_{1} ⋃ {N}_{2} ⋃ {N}_{3} \qquad ( 2 )$$

$${τ}_{j} \geq {τ}_{i} + {t}_{i j} {x}_{i j} + \overline{τ} - M ( 1 - {x}_{i j} ) , ∀ i ∈ {N}_{1} ⋃ {N}_{2} ⋃ {N}_{3} , j ∈ N \qquad ( 3 )$$

$$0 \leq {τ}_{i} \leq {T}_{max} , ∀ i ∈ N \qquad ( 4 )$$

$${\sum }_{i ∈ N} {x}_{ii} = 0 \qquad ( 5 )$$

$${\sum }_{j ∈ N} {x}_{ji} = {\sum }_{j ∈ N} {x}_{ij} = 1 , ∀ i ∈ {N}_{1} ⋃ {N}_{2} ⋃ {N}_{3} \qquad ( 6 )$$

$${\sum }_{j ∈ {N}_{1} ⋃ {N}_{2} ⋃ {N}_{3}} {a}_{ij} = {\sum }_{j ∈ {N}_{1} ⋃ {N}_{2} ⋃ {N}_{3}} {b}_{j i} = \vert {N}_{3} \vert , ∀ i ∈ {N}_{0} \qquad ( 7 )$$

$${\sum }_{j ∈ {N}_{1} ⋃ {N}_{2} ⋃ {N}_{3}} {a}_{j i} = {\sum }_{j ∈ {N}_{1} ⋃ {N}_{2} ⋃ {N}_{3}} {b}_{i j} = 0 , ∀ i ∈ {N}_{0} \qquad ( 8 )$$

$${\sum }_{j ∈ N} {a}_{ij} - {\sum }_{j ∈ N} {a}_{ji} = - 1 , ∀ i ∈ {N}_{1} \qquad ( 9 )$$

$${\sum }_{j ∈ N} {a}_{ij} - {\sum }_{j ∈ N} {a}_{ji} = 1 , ∀ i ∈ {N}_{2} \qquad ( 10 )$$

$${\sum }_{j ∈ N} {a}_{ij} - {\sum }_{j ∈ N} {a}_{ji} = 0 , ∀ i ∈ {N}_{3} \qquad ( 11 )$$

$${\sum }_{j ∈ N} {b}_{ij} - {\sum }_{j ∈ N} {b}_{ji} = 0 , ∀ i ∈ {N}_{1} ⋃ {N}_{2} \qquad ( 12 )$$

$${\sum }_{j ∈ N} {b}_{ij} - {\sum }_{j ∈ N} {b}_{ji} = 1 , ∀ i ∈ {N}_{3} \qquad ( 13 )$$

$${a}_{i j} + {b}_{i j} \leq Q {x}_{i j} , ∀ i , j ∈ N \qquad ( 14 )$$

$${x}_{i j} ∈ \{ 0 , 1 \} , {a}_{i j} , {b}_{i j} \geq 0 , {a}_{i j} , {b}_{i j} ∈ Z , ∀ i , j ∈ N \qquad ( 15 )$$

In the foregoing model, the expression (1) is to minimize the labor costs and transportation costs of the vehicle. The expressions (2) and (3) are elimination methods of sub-loops on the rebalancing route. Sub-loops and self-loops are two concepts in the optimization of the rebalancing route of the vehicle. The sub-loops mean that the vehicle continuously travels in a small circle on the rebalancing route of a large circle. The self-loops mean that the vehicle continuously travels around a location in circles. The expression (4) is a rebalancing time constraint, considering the features of the rebalancing time of the vehicle. The expression (5) is an elimination method of self-loops on the rebalancing route. The expression (6) is a flow balance constraint during the rebalancing operations. The expressions (7) and (8) are constraints of numbers of shared bikes carried by the vehicle in the start and end location. The expressions (9), (10), and (11) represent a change in the number of unbroken shared bicycles in the vehicle after the vehicle passes through locations of types N₁, N₂, and N₃, considering pickup-and-delivery actions in different locations. The expressions (12) and (13) represent a change in the number of broken shared bikes in the vehicle after the vehicle passes through the locations of the types N₁ and N₂, considering the pickup-and-delivery actions of the vehicle in different locations. The expression (14) is a capacity constraint of the vehicle, considering the features of the capacity limit of the vehicle. The expression (15) is a non-negative integer constraint of the decision variable.

D1 Design an adaptive operator selection mechanism.

At the beginning of each execution, set a same score for various operators, such as 100 points. In each subsequent iteration, if a solution searched by a selected operator is better than all the previous solutions, a fixed score, such as 10 points, is added to the operator. If the solution searched by the selected operator is better only than a solution in a previous generation, a fixed score, such as 5 points, is added to the operator. If the solution searched by the selected operator does not have any improvement, no points are added to the operator. Therefore, after calculation of each generation, each operator obtains a score. A score obtained by a k^{th} operator is denoted as δₖ. In this case, a formula for a probability that each of various operators (assuming that there are K operators) is selected in subsequent iterations is as follows:

$${p}_{k} = \frac{{δ}_{k}}{{{\sum }^{K}}_{k - 1} {δ}_{k}} . \qquad ( 16 )$$

D2 Design seven types of perturbation operators.

D2.1 Random perturbation operator. In each iteration, the operator randomly deletes a plurality of demand locations on the rebalancing route of the vehicle and puts the deleted demand locations back into an unallocated demand pool.

D2.2 Distance preorder perturbation operator. In each iteration, the operator first calculates a distance between each demand location and its neighboring demand location, sorts all demand locations in descending order of the distance, deletes first a plurality of (for example, four) demand locations, and puts the deleted demand locations back into the unallocated demand pool.

D2.3 Distance postorder perturbation operator. In each iteration, the operator first calculates the distance between each demand location and its neighboring demand location, sorts all the demand locations in descending order of the distance, deletes last a plurality of (for example, four) demand locations, and puts the deleted demand locations back into the unallocated demand pool.

D2.4 Mean distance preorder perturbation operator. In each iteration, the operator first calculates the distance between each demand location and its neighboring demand location and a mean of the distances, then calculates a difference between the mean and the distance between each demand location and its neighboring demand location, sorts all the demand locations in descending order of the difference, deletes first a plurality of (for example, four) demand locations, and puts the deleted demand locations back into the unallocated demand pool.

D2.5 Mean distance postorder perturbation operator. In each iteration, the operator first calculates the distance between each demand location and its neighboring demand location and the mean of the distances, then calculates the difference between the mean and the distance between each demand location and its neighboring demand location, sorts all the demand locations in descending order of the difference, deletes last a plurality of (for example, four) demand locations, and puts the deleted demand locations back into the unallocated demand pool.

D2.6 Random distance preorder perturbation operator. In each iteration, the operator first randomly selects a demand location, calculates a distance between the demand location and its neighboring demand location and the distance between each demand location and its neighboring demand location, then calculates a difference between the distance and the distance for the randomly selected demand location, sorts all the demand locations in descending order of the difference, deletes first a plurality of (for example, four) demand locations, and puts the deleted demand locations back into the unallocated demand pool.

D2.7 Random distance postorder perturbation operator. In each iteration, the operator first randomly selects a demand location, calculates the distance between the demand location and its neighboring demand location and the distance between each demand location and its neighboring demand location, then calculates a difference between the distance and the distance for the randomly selected demand location, sorts all the demand locations in descending order of the difference, deletes last a plurality of (for example, four) demand locations, and puts the deleted demand locations back into the unallocated demand pool.

D3 Design six types of repair operators.

D3.1 Random repair operator. The operator randomly selects a demand location from the unallocated demand pool each time and randomly inserts the demand location into a feasible location in the current solution, and repeats this process until the demand pool is empty to obtain a repaired rebalancing route of shared bikes.

D3.2 Optimal repair operator. The operator randomly selects a demand location from the unallocated demand pool each time, tries to insert the demand location into all feasible locations in the current solution, calculates corresponding incremental rebalancing costs after insertion, and inserts the previously selected demand location into a feasible location corresponding to a smallest incremental rebalancing cost, and repeats this process until the demand pool is empty to obtain the repaired route of the rebalancing operations.

D3.3 Preorder repair operator. The operator randomly selects a demand location from the unallocated demand pool each time and inserts the demand location into a first feasible location in the current solution, and repeats this process until the demand pool is empty to obtain the repaired route of the rebalancing operations.

D3.4 Postorder repair operator. The operator randomly selects a demand location from the unallocated demand pool each time and inserts the demand location into a last feasible location in the current solution, and repeats this process until the demand pool is empty to obtain the repaired route of the rebalancing operations.

D3.5 Maximum regret repair operator. The operator calculates a smallest incremental rebalancing cost and a second smallest incremental rebalancing cost when each demand location in the demand pool is inserted into the current solution each time, then calculates a difference between the two incremental rebalancing costs to obtain a regret value after insertion, sorts all the demand locations in descending order of the regret value, and inserts a demand location corresponding to a largest regret value into a location with the smallest incremental rebalancing cost in the current solution, and repeats this process until the demand pool is empty to obtain the repaired rebalancing route of shared bikes.

D3.6 Minimum regret repair operator. The operator calculates the smallest incremental rebalancing cost and second smallest incremental rebalancing cost when each demand location in the demand pool is inserted into the current solution each time, then calculates the difference between the two incremental rebalancing costs to obtain the regret value after insertion, sorts all the demand locations in descending order of the regret value, and inserts a demand location corresponding to a smallest regret value into a location with the smallest incremental rebalancing cost in the current solution, and repeats this process until the demand pool is empty to obtain the repaired rebalancing route of shared bikes.

D4 Design eight types of neighborhood search operators.

D4.1 Single-route point crossover operator. In each iteration, the operator randomly selects two demand locations from a first rebalancing route and swaps the two demand locations, and if the constraint conditions of the model are not met after the swapping, reselects two demand locations, and otherwise, obtains a rebalancing route after the swapping, and then repeats this process for a second rebalancing route until all routes are searched.

D4.2 Single-route point-pair crossover operator. In each iteration, the operator randomly selects two pairs of demand locations (a pair of demand locations is composed of a delivery location and a pickup location) from a first rebalancing route and swaps the two pairs of demand locations, and if the constraint conditions of the model are not met after the swapping, reselects two pairs of demand locations, and otherwise, obtains a rebalancing route after the swapping, and then repeats this process for a second rebalancing route until all routes are searched.

D4.3 Single-route delete-reinsert operator. In each iteration, the operator first randomly selects a demand location from a rebalancing route, deletes the demand location from the route, and then reinserts the demand location into another feasible location on the rebalancing route, and repeats this process for a second route until all routes are searched.

D4.4 Single-route segment crossover operator. In each iteration, the operator randomly selects two demand location segments (each demand location segment is composed of the same number of adjacent demand locations) from a rebalancing route and swaps the two demand location segments, and if the constraint conditions of the model are not met after the swapping, reselects two demand location segments, and otherwise, obtains a rebalancing route after the swapping, and then repeats this process for a second rebalancing route until all routes are searched.

D4.5 Dual-route point crossover operator. In each iteration, the operator first selects two rebalancing routes, randomly selects a demand location from each route, and swaps the demand locations selected from the two routes, and if the constraint conditions of the model are not met after the swapping, reselects a demand location from each route, and otherwise, obtains two rebalancing routes after the swapping, and then repeats this process for remaining rebalancing routes until all routes are searched.

D4.6 Dual-route point-pair crossover operator. In each iteration, the operator first selects two rebalancing routes, randomly selects a pair of demand locations (which is composed of a delivery location and a pickup location) from each route, and swaps the two pairs of demand locations selected from the two routes, and if the constraint conditions of the model are not met after the swapping, reselects a pair of demand locations from each route, and otherwise, obtains two rebalancing routes after the swapping, and then repeats this process for remaining rebalancing routes until all routes are searched.

D4.7 Dual-route delete-reinsert operator. In each iteration, the operator first selects two rebalancing routes, randomly selects and deletes a demand location from a first route, and inserts the deleted demand location into a feasible location on a second route to obtain two rebalancing routes after swapping, and repeats this process for remaining rebalancing routes until all routes are searched.

D4.8 Dual-route segment crossover operator. In each iteration, the operator first selects two rebalancing routes, randomly selects a demand location segment (which is composed of the same number of adjacent demand locations) from each route, and swaps the demand location segments selected from the two routes, and if the constraint conditions of the model are not met after the swapping, reselects a demand location segment from each route, and otherwise, obtains two rebalancing routes after the swapping, and then repeats this process for remaining rebalancing routes until all routes are searched.

D5 Design termination conditions of the adaptive neighborhood search algorithm.

Set a calculation duration threshold (for example, 10 minutes) of the adaptive neighborhood search algorithm. If current calculation duration of the algorithm exceeds this threshold, it is considered that a first termination condition is met. Set an improvement step (for example, 10) of the algorithm. If a target value of the solution obtained in iterations of the algorithm has no improvement for 10 consecutive times, it is considered that a second termination condition is met. During calculation of the algorithm, if and only if the two termination conditions are not met, the adaptive neighborhood search algorithm continues the calculation. If any one of the termination conditions is met, the algorithm immediately stops the calculation and returns the current searched rebalancing route with the smallest rebalancing cost.

The present disclosure will be described below with reference to specific embodiments.

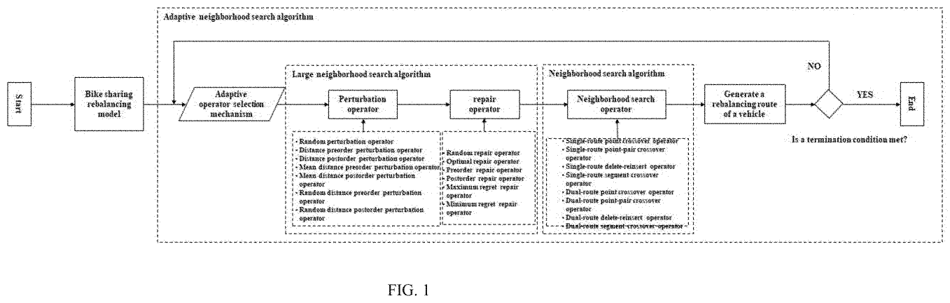

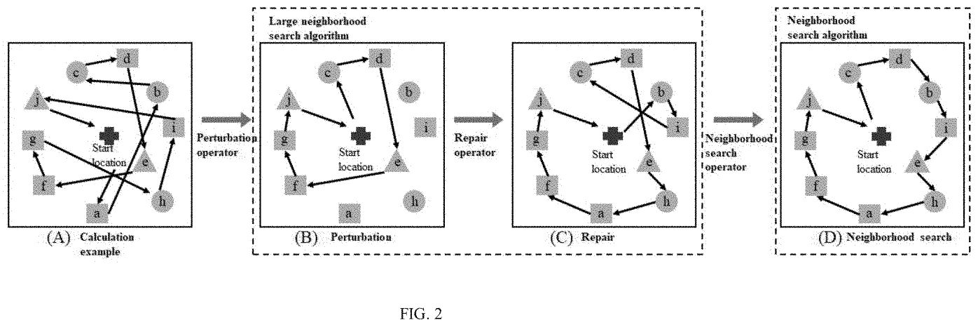

In a calculation example shown in FIG. 2 (A), there are 10 demand locations, of which there are five locations of type N₁ (a, d, i, g, and f), three locations of type N₂ (c, b, and h), two locations of type N₃ (e and j), and one location of type N₀ (namely, a start and end location). The arrows in FIG. 2 form a rebalancing route. In this case, there is one vehicle. At the beginning of the algorithm, each operator is assigned a weight of 100 points. A probability that each operator is selected is calculated by using the expression (16). It is assumed that three search operators D2.1, D3.1, and D4.2 are selected by using a roulette wheel selection method. During calculation of the algorithm, an implementation process of D2.1 is a process from (A) to (B) in FIG. 2, that is, the demand locations a, h, b, and i in FIG. 2 (A) are deleted from the rebalancing route by the random perturbation operator. These four demand locations constitute an unallocated demand pool. An implementation process of D3.1 is a process from (B) to (C) in FIG. 2, that is, a, h, b, and i in FIG. 2 (B) are respectively reinserted into the rebalancing route by the random repair operator. The arrows in FIG. 2 (C) constitute a repaired rebalancing route. It can be learned that the route in FIG. 2 (C) after the repair is better than the route in FIG. 2 (A) before the repair. An implementation process of D4.2 is a process from (C) to (D) in FIG. 2, that is, demand location pairs b and i, and c and d are swapped on the rebalancing route, forming a new rebalancing route. It can be learned that the route in FIG. 2 (D) is better than the route in FIG. 2 (C). The foregoing processes show that the three search operators D2.1, D3.1 and D4.2 all exert their respective search capabilities, and quality of the obtained solutions is gradually improved. In this case, scores of D2.1, D3.1, and D4.2 can be simultaneously increased by 10 points to reach 110 points, and scores of other unselected operators are still 100 points. The execution processes of adaptive operator selection, the perturbation operator, the repair operator, and the neighborhood search operator are re-entered based on the procedure shown in FIG. 1. For simplicity, implementation processes of other operators are not described herein. Finally, after a termination condition of the algorithm is met (for example, there is no improvement in the solution result after 10 iterations), the algorithm terminates and returns the current searched rebalancing route. For example, it is assumed that after the adaptive neighborhood search algorithm is executed 10 times for the calculation example in FIG. 2, the obtained rebalancing route is still shown in FIG. 2 (D). In this case, the rebalancing route is returned. It can be learned that the rebalancing route at this time has a lot of improvement compared with the previous route.

Finally, it should be noted that the foregoing embodiments are used only to illustrate the technical solutions of the present disclosure, and are not intended to limit same. Although the present disclosure is described in detail with reference to the foregoing embodiments, those of ordinary skill in the art should understand that they can still modify the technical solutions described in the foregoing embodiments, or make equivalent substitutions to some technical features therein. These modifications or substitutions do not make the essence of the corresponding technical solutions depart from the spirit and scope of the technical solutions of the embodiments of the present disclosure.

What is claimed is:

1. A bike sharing rebalancing optimization method based on an adaptive neighborhood search algorithm, comprising the following steps:
step 1: constructing, based on locations of shared bikes, users' travel demands, and demand locations to which a vehicle transports the shared bikes, a bike sharing rebalancing model aiming to minimize rebalancing costs; and
step 2: designing an adaptive operator selection mechanism based on a rebalancing time, pickup-and-delivery actions, and a capacity limit of the vehicle in the bike sharing rebalancing model, and constructing the adaptive neighborhood search algorithm based on the fusion of a large neighborhood search algorithm and a neighborhood search algorithm, and solving the bike sharing rebalancing model to obtain an optimal rebalancing route of each vehicle; wherein
the large neighborhood search algorithm is composed of a perturbation process and a repair process, the perturbation process is used to delete demand locations on the rebalancing route of the vehicle in the bike sharing rebalancing model, to provide space for improvement of the rebalancing route of the vehicle, and the repair process is used to reinsert the demand locations deleted by the perturbation process into the rebalancing route of the vehicle, to reduce the rebalancing costs in the bike sharing rebalancing model; and
the neighborhood search algorithm is composed of a neighborhood search process, and the neighborhood search process is used to swap the demand locations repaired by the repair process on the rebalancing route of the vehicle, to reduce the rebalancing costs in the bike sharing rebalancing model.

2. The bike sharing rebalancing optimization method based on an adaptive neighborhood search algorithm according to claim 1, wherein in step 1, the bike sharing rebalancing model is composed of two parts: an objective function and constraint conditions, wherein
the objective function is as follows:
$$Min {\sum }_{i ∈ {N}_{0}} {\sum }_{j ∈ {N}_{1} ⋃ {N}_{2} ⋃ {N}_{3}} {Cx}_{i j} + {\sum }_{i ∈ {N}_{0}} {\sum }_{j ∈ {N}_{1} ⋃ {N}_{2} ⋃ {N}_{3}} α {t}_{i j} {x}_{i j} \qquad ( 1 )$$
the constraint conditions are as follows:
$${τ}_{j} \geq {t}_{i j} {x}_{i j} - M ( 1 - {x}_{i j} ) , ∀ i ∈ {N}_{0} , j ∈ {N}_{1} ⋃ {N}_{2} ⋃ {N}_{3} \qquad ( 2 )$$
$${τ}_{j} \geq {τ}_{i} + {t}_{i j} {x}_{i j} + \overline{τ} - M ( 1 - {x}_{i j} ) , ∀ i ∈ {N}_{1} ⋃ {N}_{2} ⋃ {N}_{3} , j ∈ N \qquad ( 3 )$$
$$0 \leq {τ}_{i} \leq {T}_{max} , ∀ i ∈ N \qquad ( 4 )$$
$${\sum }_{j ∈ N} {x}_{ii} = 0 \qquad ( 5 )$$
$${\sum }_{j ∈ N} {x}_{ji} = {\sum }_{j ∈ N} {x}_{ij} = 1 , ∀ i ∈ {N}_{1} ⋃ {N}_{2} ⋃ {N}_{3} \qquad ( 6 )$$
$${\sum }_{j ∈ {N}_{1} ⋃ {N}_{2} ⋃ {N}_{3}} {a}_{ij} = {\sum }_{j ∈ {N}_{1} ⋃ {N}_{2} ⋃ {N}_{3}} {b}_{j i} = \vert {N}_{3} \vert , ∀ i ∈ {N}_{0} \qquad ( 7 )$$
$${\sum }_{j ∈ {N}_{1} ⋃ {N}_{2} ⋃ {N}_{3}} {a}_{j i} = {\sum }_{j ∈ {N}_{1} ⋃ {N}_{2} ⋃ {N}_{3}} {b}_{i j} = 0 , ∀ i ∈ {N}_{0} \qquad ( 8 )$$
$${\sum }_{j ∈ N} {a}_{ij} - {\sum }_{j ∈ N} {a}_{ji} = - 1 , ∀ i ∈ {N}_{1} \qquad ( 9 )$$
$${\sum }_{j ∈ N} {a}_{ij} - {\sum }_{j ∈ N} {a}_{ji} = 1 , ∀ i ∈ {N}_{2} \qquad ( 10 )$$
$${\sum }_{j ∈ N} {a}_{ij} - {\sum }_{j ∈ N} {a}_{ji} = 0 , ∀ i ∈ {N}_{3} \qquad ( 11 )$$
$${\sum }_{j ∈ N} {b}_{ij} - {\sum }_{j ∈ N} {b}_{ji} = 0 , ∀ i ∈ {N}_{1} ⋃ {N}_{2} \qquad ( 12 )$$
$${\sum }_{j ∈ N} {b}_{ij} - {\sum }_{j ∈ N} {b}_{ji} = 1 , ∀ i ∈ {N}_{3} \qquad ( 13 )$$
$${a}_{i j} + {b}_{i j} \leq Q {x}_{i j} , ∀ i , j ∈ N \qquad ( 14 )$$
$${x}_{i j} ∈ \{ 0 , 1 \} , {a}_{i j} , {b}_{i j} \geq 0 , {a}_{i j} , {b}_{i j} ∈ Z , ∀ i , j ∈ N \qquad ( 15 )$$
meanings of parameters in the foregoing model are as follows:
N₀ represents a set of start locations of the vehicles;
N₁ represents a set of locations in which each shared bike needs to be delivered;
N₂ represents a set of locations in which each unbroken shared bike needs to be picked up;
N₃ represents a set of locations in which each broken shared bike needs to be picked up;
N represents a set of all the foregoing locations, and N=N₀∪N₁∪N₂∪N₃;
Q represents a capacity of the vehicle;
C represents a unit labor cost of the vehicle;
τ̅ represents a time taken by the operator (labor) to load and unload a shared bike;
α represents a unit transportation cost of the vehicle;
tᵢⱼ represents a time required for the vehicle to travel from a location i to a location j, wherein i∈N and j∈N;
Tₘₐₓ represents a maximum operational time allowed for rebalancing operations of shared bikes;
xᵢⱼ represents whether the vehicle travels from the location i to the location j, and if yes, xᵢⱼ is 1, otherwise, xᵢⱼ is 0, where i∈N and j∈N;
xⱼᵢ represents whether the vehicle travels from the location j to the location i, and if yes, xⱼᵢ is 1, otherwise, xⱼᵢ is 0, where i∈N and j∈N;
xᵢᵢ represents whether the vehicle travels from the location i to the location i, and if yes, xᵢᵢ is 1, otherwise, xᵢᵢ is 0, where i∈N and j∈N;
τᵢ represents a time point at which the vehicle arrives at the location i, where i∈N;
τⱼ represents a time point at which the vehicle arrives at the location j, where j∈N;
aᵢⱼ represents the number of unbroken shared bikes carried by the vehicle on a route from the location i to the location j, where i∈N and j∈N;
aⱼᵢ represents the number of unbroken shared bikes carried by the vehicle on a route from the location j to the location i, where i∈N and j∈N;
bᵢⱼ represents the number of broken shared bikes carried by the vehicle on the route from the location i to the location j, where i∈N and j∈N;
bⱼᵢ represents the number of broken shared bikes carried by the vehicle on the route from the location j to the location i, where i∈N and j∈N;
M represents a very large value in the mathematical model, and for example, M may be 1,000,000 in a implementation process; and
Z represents that an obtained value is an integer.

3. The bike sharing rebalancing optimization method based on an adaptive neighborhood search algorithm according to claim 1, wherein step 2 specifically comprises assigning different weights to search capabilities of perturbation operators, repair operators, and neighborhood search operators, and constructing the adaptive operator selection mechanism by using a roulette wheel selection method.

4. The bike sharing rebalancing optimization method based on an adaptive neighborhood search algorithm according to claim 1, wherein in step 2, there are seven types of perturbation operators: a random perturbation operator, a distance preorder perturbation operator, a distance postorder perturbation operator, a mean distance preorder perturbation operator, a mean distance postorder perturbation operator, a random distance preorder perturbation operator, and a random distance postorder perturbation operator; and the adaptive neighborhood search algorithm selects an operator with a strongest capability from the seven operators when using the perturbation operator, such that as calculation proceeds, the seven operators play their respective search advantages in a solution space of the bike sharing rebalancing model;
there are six types of repair operators: a random repair operator, an optimal repair operator, a preorder repair operator, a postorder repair operator, a maximum regret repair operator, and a minimum regret repair operator; and the adaptive neighborhood search algorithm selects an operator with a strongest capability from the six operators when using the repair operator, such that the six operators play their respective repair advantages in the solution space of the bike sharing rebalancing model; and
there are eight types of neighborhood search operators: a single-route point crossover operator, a single-route point-pair crossover operator, a single-route delete-reinsert operator, a single-route segment crossover operator, a dual-route point crossover operator, a dual-route point-pair crossover operator, a dual-route delete-reinsert operator, and a dual-route segment crossover operator; and the adaptive neighborhood search algorithm selects an operator with a strongest capability from the eight operators when using the neighborhood search operator, such that the eight operators play their respective search advantages in the solution space of the bike sharing rebalancing model.

5. The bike sharing rebalancing optimization method based on an adaptive neighborhood search algorithm according to claim 4, wherein the seven perturbation operators are constructed as follows:
(1) constructing the random perturbation operator by randomly deleting 40% of rebalancing demand locations and putting the deleted rebalancing demand locations into a demand pool;
(2) constructing the distance preorder perturbation operator by calculating a distance between each rebalancing demand location and its neighboring location, sorting all the rebalancing demand locations in descending order of the distance, deleting first 40% of the rebalancing demand locations, and putting the deleted rebalancing demand locations into the demand pool;
(3) constructing the distance postorder perturbation operator by calculating the distance between each rebalancing demand location and its neighboring location, sorting all the rebalancing demand locations in descending order of the distance, deleting last 40% of the rebalancing demand locations, and putting the deleted rebalancing demand locations into the demand pool;
(4) constructing the mean distance preorder perturbation operator by calculating the distance between each rebalancing demand location and its neighboring location and a mean of the distances, sorting all the rebalancing demand locations in descending order of a difference between the distance and the mean, deleting first 40% of the rebalancing demand locations, and putting the deleted rebalancing demand locations into the demand pool;
(5) constructing the mean distance postorder perturbation operator by calculating the distance between each rebalancing demand location and its neighboring location and the mean of the distances, sorting all the rebalancing demand locations in descending order of the difference between the distance and the mean, deleting last 40% of the rebalancing demand locations, and putting the deleted rebalancing demand locations into the demand pool;
(6) constructing the random distance preorder perturbation operator by calculating the distance between each rebalancing demand location and its neighboring location, sorting all the rebalancing demand locations in descending order of a difference between the distance and a distance corresponding to a randomly selected demand location, deleting first 40% of the rebalancing demand locations, and putting the deleted rebalancing demand locations into the demand pool; and
(7) constructing the random distance postorder perturbation operator by calculating the distance between each rebalancing demand location and its neighboring location, sorting all the rebalancing demand locations in descending order of the difference between the distance and the distance corresponding to the randomly selected demand location, deleting last 40% of the rebalancing demand locations, and putting the deleted rebalancing demand locations into the demand pool.

6. The bike sharing rebalancing optimization method based on an adaptive neighborhood search algorithm according to claim 4, wherein the six repair operators are constructed as follows:
(1) constructing the random repair operator by randomly selecting a rebalancing demand location in the demand pool each time and putting the selected rebalancing demand location into the rebalancing route;
(2) constructing the optimal repair operator by selecting a rebalancing demand location in the demand pool each time and putting the selected rebalancing demand location into a feasible location with a minimum incremental rebalancing cost on the rebalancing route;
(3) constructing the preorder repair operator by selecting a rebalancing demand location in the demand pool each time and putting the selected rebalancing demand location into a first feasible location on the rebalancing route;
(4) constructing the postorder repair operator by selecting a rebalancing demand location in the demand pool each time and putting the selected rebalancing demand location into a last feasible location on the rebalancing route;
(5) constructing the maximum regret repair operator by calculating a difference between incremental rebalancing costs after each rebalancing demand location in the demand pool is put into an optimal location and a suboptimal location on the rebalancing route, and putting a rebalancing demand location corresponding to a largest difference into the rebalancing route; and
(6) constructing the minimum regret repair operator by calculating the difference between the incremental rebalancing costs after each rebalancing demand location in the demand pool is put into the optimal location and the suboptimal location on the rebalancing route, and putting a rebalancing demand location corresponding to a smallest difference into the rebalancing route.

7. The bike sharing rebalancing optimization method based on an adaptive neighborhood search algorithm according to claim 4, wherein the eight neighborhood search operators are constructed as follows:
(1) constructing the single-route point crossover operator by randomly swapping two rebalancing demand locations on a single rebalancing route;
(2) constructing the single-route point-pair crossover operator by randomly swapping two pairs of delivery and pickup rebalancing demand locations on a single rebalancing route;
(4) constructing the single-route delete-reinsert operator by randomly deleting a rebalancing demand location from a single rebalancing route and reinserting the rebalancing demand location into another feasible location on the route;
(5) constructing the single-route segment crossover operator by randomly swapping three adjacent rebalancing demand locations on a single rebalancing route;
(6) constructing the dual-route point crossover operator by randomly swapping two rebalancing demand locations of a same type respectively on two rebalancing routes;
(7) constructing the dual-route point-pair crossover operator by randomly swapping two pairs of delivery and pickup rebalancing demand locations of a same type respectively on two rebalancing routes;
(8) constructing the dual-route delete-reinsert operator by randomly deleting a rebalancing demand location from a rebalancing route and reinserting the rebalancing demand location into a feasible location on another rebalancing route; and
(9) constructing the dual-route segment crossover operator by randomly swapping three adjacent rebalancing demand locations on a rebalancing route with those on another rebalancing route.

8. The bike sharing rebalancing optimization method based on an adaptive neighborhood search algorithm according to claim 1, wherein step 2 further comprises: constructing termination conditions of the adaptive neighborhood search algorithm based on calculation duration and a calculation effect of the adaptive neighborhood search algorithm during execution, and if one of the termination conditions is met during the execution of the adaptive neighborhood search algorithm, returning a current rebalancing route of the vehicle; otherwise, substituting the rebalancing route of the vehicle into the adaptive neighborhood search algorithm again for calculation until one of the termination condition is met, and obtaining the rebalancing route of the vehicle after termination.

9. The bike sharing rebalancing optimization method based on an adaptive neighborhood search algorithm according to claim 8, wherein the termination conditions of the adaptive neighborhood search algorithm are designed as follows:
(1) comparing a calculation duration threshold with the current calculation duration of the adaptive neighborhood search algorithm, wherein if the current calculation duration exceeds the threshold, the adaptive neighborhood search algorithm terminates the calculation; otherwise, continues the calculation; and
(2) comparing the rebalancing cost of the rebalancing route obtained in each iteration of the adaptive neighborhood search algorithm, wherein if the rebalancing cost does not change for a plurality of consecutive times, the adaptive neighborhood search algorithm terminates the calculation; otherwise, continues the calculation.
